(19) United States
(12) Patent Application Publication
(10) Pub. No.: US 2026/0331362 A1
(43) Pub. Date: Oct. 22, 2026

(54) MINIATURE POWER GENERATION DEVICE

(71) Applicant: Foshan Shunde Advante Electron Ltd., Foshan (CN)

(72) Inventor: Feizhang ZOU, Foshan (CN)

(21) Appl. No.: 19/529,449

(22) Filed: Feb. 4, 2026

Related U.S. Application Data
(63) Continuation of application No. PCT/CN2025/099790, filed on Jun. 7, 2025.

(30) Foreign Application Priority Data
Jul. 26, 2024 (CN) 202421804124.0

(51) Int. Cl. H01F 27/30; H01F 7/02; H01F 7/20

(52) U.S. Cl. CPC H01F 27/306; H01F 7/0205; H01F 7/20

(57) ABSTRACT

The present invention discloses a miniature power generation device, comprising a bracket, a coil, a first magnetic conductive plate, a second magnetic conductive plate, and a permanent magnet, with the coil wound around the bracket; the first magnetic conductive plate comprises a first planar portion and a first bending portion; the second magnetic conductive plate comprises a second planar portion and a second bending portion. Therefore, setting up the first bending portion and second bending portion saves the additional magnetic shims and clips, simplifying the production process and reducing manufacturing costs, and ensuring power generation efficiency.

### CROSS-REFERENCE TO RELATED APPLICATIONS

This application is a continuation of International Application No. PCT/CN2025/099790, filed on Jun. 07, 2025, which claims priority to Chinese Patent Application No. 202421804124.0, filed with the China National Intellectual Property Administration on Jul. 26, 2024, both of which are hereby incorporated by reference in their entireties.

### TECHNICAL FIELD

The present invention relates to the field of micro electric power generation technology, specifically to a miniature power generation device.

### BACKGROUND

By utilizing the pressing force of hands or external micro mechanical pressure, the existing miniature power generation devices provide an alternative solution for small low-power electronic products, including two magnets, two magnetic conductive plates, a bracket, a coil wound on the bracket, and a magnetic conductive plate disposed in the center of the bracket, the two magnets are installed at both ends of the bracket and located on both sides of the coil, and the two magnetic conductive plates are disposed on the upper and lower sides of the bracket.

In practical applications, however, it has been found that the magnetic conductive plate is usually flat in shape and when the permanent magnet is installed on the bracket, there is a large gap between the permanent magnet and the magnetic conductive plate, so it is necessary to add magnetic shims to fill this gap to achieve magnetic conduction between the magnetic conductive plate and the permanent magnet and secondly, the presence of magnetic shims will occupy most of the space on the bracket, causing the magnetic conductive plate to be unable to be directly fixed on the bracket. Therefore, additional clips need to be provided to clamp the magnetic conductive plate to fix it on the bracket, thereby increasing the structural complexity and at the same time, setting clips also increases the thickness, resulting in a large volume, which is not easy to use in combination, accompanied with low flexibility. Moreover, the limited space between clips and magnetic shims may also affect the direction change of the magnetic field of magnetic conductive plate, thereby affecting the power generation efficiency.

### SUMMARY

In order to overcome the shortcomings of the prior art mentioned above, the present invention provides a miniature power generation device, and setting up a first bending portion and a second bending portion avoids the need to add additional shims to fill the gap between the permanent magnet and the first and second magnetic conductive plates, also dispensing with additional clips, reducing the product volume, and facilitating combination use, thereby simplifying the production process and lowering manufacturing costs. In addition, it can avoid the influence of clips and magnetic shims on the direction of magnetic field, ensuring power generation efficiency and significantly improving the user experience.

The present invention solves the problem by adopting the following technical solution:

A miniature power generation device, comprising:
a bracket and a coil, wherein the coil is wound around the bracket; a first magnetic conductive plate comprising a first planar portion and a first bending portion disposed at one end of the first planar portion;
the first bending portion comprises a first flanging connected to one end of the first planar portion and disposed vertically, and
a second flanging disposed horizontally and located at the bottom of the first flanging;
a second magnetic conductive plate comprising a second planar portion and a second bending portion disposed at one end of the second planar portion; the second bending portion comprises a third flanging connected to one end of the second planar portion and disposed vertically, and a fourth flanging disposed horizontally and located at the bottom of the third flanging;
a permanent magnet disposed at one end of the bracket;
one end of the bracket is, from upper to lower, provided with a first slot and a second slot, and the second flanging is inserted into the first slot to be fixed at the top of the bracket, and the second flanging is inserted into the top of the permanent magnet to achieve magnetic conductivity; the fourth flanging is inserted into the second slot to be fixed at the bottom of the bracket, and the fourth flanging abuts against the bottom of the permanent magnet to achieve magnetic conductivity.

In further, a first buckle and a second buckle are, from upper to lower, provided at the other end of the bracket, the first magnetic conductive plate is provided with a first groove that fits the first buckle, the second magnetic conductive plate is provided with a second groove that fits the second buckle, the first groove is snap-fitted to the first buckle, and the second groove is snap-fitted to the second buckle to fix the first magnetic conductive plate and the second magnetic conductive plate on the upper side and lower side of the bracket, respectively.

In further, a first buckle site and a second buckle site are provided, from front to rear, at the top of the other end of the bracket, a first clamping block and a second clamping block are provided, from front to rear, in the middle of the other end of the bracket, a first gap is disposed between the first clamping block and the first buckle site, a second gap is disposed between the second clamping block and the second buckle site, and the first slot is formed between the first gap and the second gap;

a third buckle and a fourth buckle are provided, from front to rear, at the bottom of the other end of the bracket, a third gap is disposed between the first clamping block and the third buckle, a fourth gap is disposed between the second clamping block and the fourth buckle, and the second slot is formed between the third gap and the fourth gap.

In further, a first limit block and a second limit block are provided, front front to rear, in the middle of the other end of the bracket, the first limit block, second limit block, second clamping block, and first clamping block enclose to form an installation groove in where the permanent magnet is installed, and the first clamping block and the second clamping block are clamped on both sides of the permanent magnet, respectively.

In further, the miniature power generation device further comprises a magnetic swing plate, the bracket is provided with a cavity having two open ends, the upper and lower walls of the cavity are provided with two pivot points for swinging that correspond vertically; the magnetic swing plate is disposed in the cavity and located between two pivot points, and swings up and down inside the cavity.

In further, the first magnetic conductive plate further comprises a fifth flanging disposed at the other end of the first planar portion and folded downward; the second magnetic conductive plate further comprises a sixth flanging disposed at the other end of the second planar portion and folded downward;

when swinging up and down inside the cavity, the magnetic swing plate abuts against the fifth flanging and fourth flanging to achieve magnetic conduction, or the sixth flanging and second flanging to achieve magnetic conduction.

In further, the miniature power generation device further comprises a spring piece disposed at one end of the magnetic swing plate, and the spring piece during action drives the magnetic swing plate to swing up and down in the cavity.

In further, one end of the magnetic swing plate is provided with a first connection hole, the spring piece is provided with a second connection hole, the spring piece runs through the first connection hole and the second connection hole and is fixed on one end of the magnetic swing plate by a fastener.

In further, the miniature power generation device further comprises a torsion spring for providing upward reset elastic force to the spring piece, and the torsion spring abuts against the spring piece.

In further, the first flanging and the first planar portion, the second flanging and the first flanging, and the fifth flanging and the first planar portion are all provided with rounded transitions;

the third flanging and the second planar portion, the fourth flanging and the third flanging, and the sixth flanging and the second planar portion are all provided with rounded transitions.

In overall, the present invention provides a miniature power generation device, and setting up a first bending portion and a second bending portion avoids the need to add additional shims to fill the gap between the permanent magnet and the first and second magnetic conductive plates, also dispensing with additional clips, reducing the product volume, and facilitating combination use, thereby simplifying the production process and lowering manufacturing costs. In addition, it can avoid the influence of clips and magnetic shims on the direction of magnetic field, ensuring power generation efficiency and significantly improving the user experience.

For the miniature power generation device of the present invention, the first magnetic conductive plate is also fixed on the top of the bracket by being snap-fitted to the first buckle through the first groove; the second magnetic conductive plate is also fixed at the bottom of the bracket by being snap-fitted to the second buckle through the second groove, which improves the firmness of connection between the first magnetic conductive plate, the second magnetic conductive plate and the bracket, while dispensing with additional magnetic shims and clips, reducing the volume, avoiding the influence of clips and magnetic shims on the direction of magnetic field, and ensuring power generation efficiency.

### BRIEF DESCRIPTION OF THE DRAWINGS

FIG. 1 is a structural diagram of the miniature power generation device of the present invention;

FIG. 2 is an exploded schematic diagram of FIG. 1;

FIG. 3 is sectional view I of the first state of the magnetic swing plate in FIG. 1;

FIG. 4 is sectional view II of the second state of the magnetic swing plate in FIG. 1;

FIG. 5 is a structural diagram of the bracket and coil in the miniature power generation device of the present invention;

FIG. 6 is a structural diagram of the bracket and coil in the miniature power generation device of the present invention from another perspective;

FIG. 7 is a structural diagram of the first magnetic conductive plate in the miniature power generation device of the present invention;

FIG. 8 is a structural diagram of the second magnetic conductive plate in the miniature power generation device of the present invention;

FIG. 9 is a structural diagram of the torsion spring in the miniature power generation device of the present invention.

Where, the symbols in the drawings have the following meanings:
1. Bracket; 11. Cavity; 111. Pivot point; 12. First buckle; 121. Second buckle; 13. First limit block; 131. Second limit block; 14. First clamping block; 141. Second clamping block; 15. First buckle site; 151. Second buckle site; 152. First gap; 153. Second gap; 16. Third buckle site; 161. Fourth buckle site; 162. Third gap; 163. Fourth gap; 17. Convex platform; 18. First locating protrusion; 181. Second locating protrusion;
2. Coil;
3. First magnetic conductive plate; 31. First planar portion; 32. First groove; 33. Fifth flanging; 34. First flanging; 35. Second flanging; 36. First avoidance groove; 37. Second avoidance groove;
4. Second magnetic conductive plate; 41. Second planar portion; 42. Second groove; 43. Sixth flanging; 44. Third flanging; 45. Fourth flanging; 46. Third avoidance groove; 47. Fourth avoidance groove;
5. Magnetic swing plate; 51. First connection hole; 52. Convex block;
6. Permanent magnet;
7. Spring piece; 71. Second connection hole;
8. Fastener;
9. Support; 91. Convex pillar; 92. Torsion spring; 921. Torsion spring body; 922. Torsion beam; 93. Side edge.

### DESCRIPTION OF EMBODIMENTS

For better understanding and implementation, the technical solutions in the embodiments of the present invention will be clearly and completely described below in conjunction with the accompanying drawings.

It should be understood that, in the description of the present application, the directional or positional relationships indicated by the terms such as "center", "up", "down", "front", "back", "left", "right", "vertical", "horizontal", "top", "bottom", "inside", and "outside" are based on the directional or positional relationships shown in the accompanying drawings, and are only for the convenience of describing the present application and simplifying the description, rather than indicating or implying that the device or component referred to must have a specific orientation, must be constructed and operated in a specific orientation, and therefore they cannot be understood as a limitation of the present application.

Unless otherwise defined, all technical and scientific terms used herein have the same meanings as those commonly understood by those skilled in the art belonging to the present invention. The terms used in this specification of the present invention are only for the purpose of describing specific embodiments and are not intended to limit the present invention.

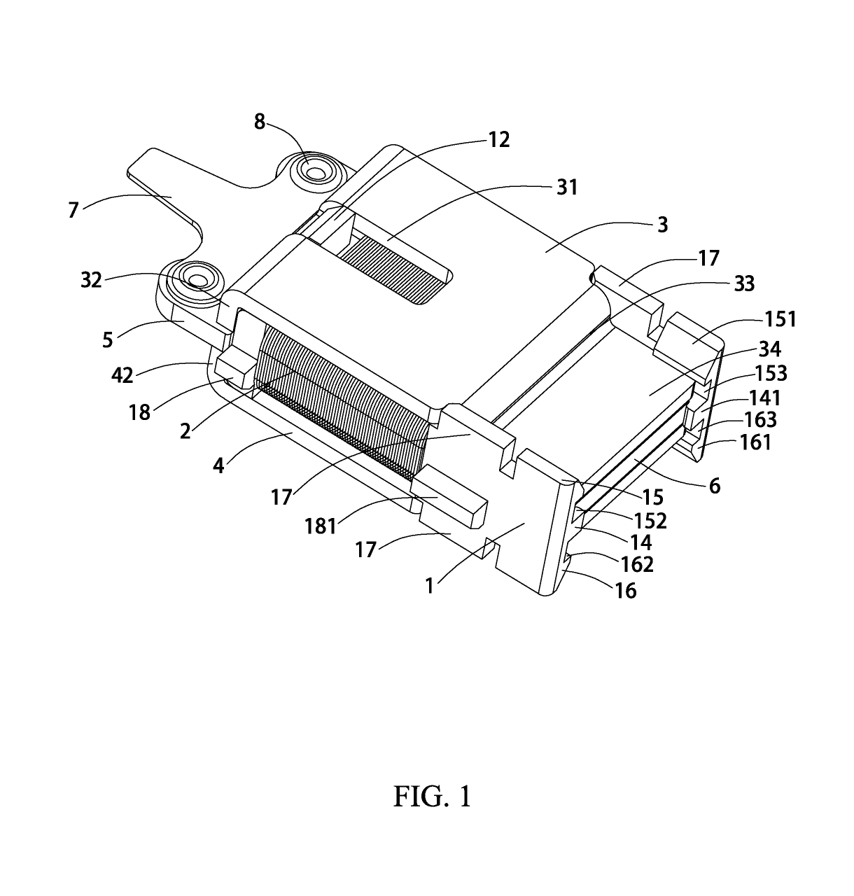

A miniature power generation device as shown in FIGS. 1-9, comprising a bracket 1, a coil 2, a first magnetic conductive plate 3, a second magnetic conductive plate 4, and a permanent magnet 6; the coil is wound around the bracket 1; the first magnetic conductive plate 3 comprises a first planar portion 31 and a first bending portion disposed at one end of the first planar portion 31; the first bending portion comprises a first flanging 34 connected to one end of the first planar portion 31 and disposed vertically, and a second flanging 35 disposed horizontally and located at the bottom of the first flanging 34; the second magnetic conductive plate 4 comprises a second planar portion 41 and a second bending portion disposed at one end of the second planar portion 41; the second bending portion comprises a third flanging 44 connected to one end of the second planar portion 41 and disposed vertically, and a fourth flanging 45 disposed horizontally and located at the bottom of the third flanging 44; a permanent magnet 6 is disposed at one end of the bracket 1; one end of the bracket 1 is, from upper to lower, provided with a first slot and a second slot, and the second flanging 35 is inserted into the first slot to be fixed at the top of the bracket 1, and the second flanging 35 is inserted into the top of the permanent magnet 6 to achieve magnetic conductivity; the fourth flanging 45 is inserted into the second slot to be fixed at the bottom of the bracket 1, and the fourth flanging 45 abuts against the bottom of the permanent magnet 6 to achieve magnetic conductivity.

Based on the above structure, a first bending portion is provided, which includes a first flanging 34 and a second flanging 35, the second flanging 35 is inserted into the first slot to fix the first magnetic conductive plate 3 on the top of the bracket 1, and the second flanging 35 abuts against the top of the permanent magnet 6 to achieve magnetic conductivity; a second bending portion is provided, which includes a third flanging 44 and a fourth flanging 45, the fourth flanging 45 is inserted into the second slot to fix the second magnetic conductive plate 4 at the bottom of the bracket 1, and the fourth flanging 45 abuts against the bottom of the permanent magnet 6 to achieve magnetic conductivity, dispensing with additional magnetic shims; setting up a first bending portion and a second bending portion helps improve the space utilization on bracket 1, allowing for the creation of a first slot and a second slot, facilitating the direct insertion and fixation of the first magnetic conductive plate 3 and the second magnetic conductive plate 4 onto bracket 1 and their contact with the permanent magnet 6 to achieve magnetic conductivity, which also dispenses with additional magnetic shims and fixing clips, reduces the product volume, and facilitates combination use, thereby simplifying the production process and lowering manufacturing costs and in addition, it can avoid the influence of clips and magnetic shims on the direction of magnetic field, ensuring power generation efficiency and significantly improving the user experience.

In further, a first buckle 12 and a second buckle 121 are, from upper to lower, provided at the other end of the bracket 1, the first magnetic conductive plate 3 is provided with a first groove 32 that fits the first buckle 12, the second magnetic conductive plate 4 is provided with a second groove 42 that fits the second buckle 121, the first groove 32 is snap-fitted to the first buckle 12, and the second groove 42 is snap-fitted to the second buckle 121 to fix the first magnetic conductive plate 3 and the second magnetic conductive plate 4 on the upper side and lower side of the bracket 1, respectively, improving the firmness of the connection between the first magnetic conductive plate 3, the second magnetic conductive plate 4, and the bracket 1, while also dispensing with additional magnetic shims and clips, reducing the product volume.

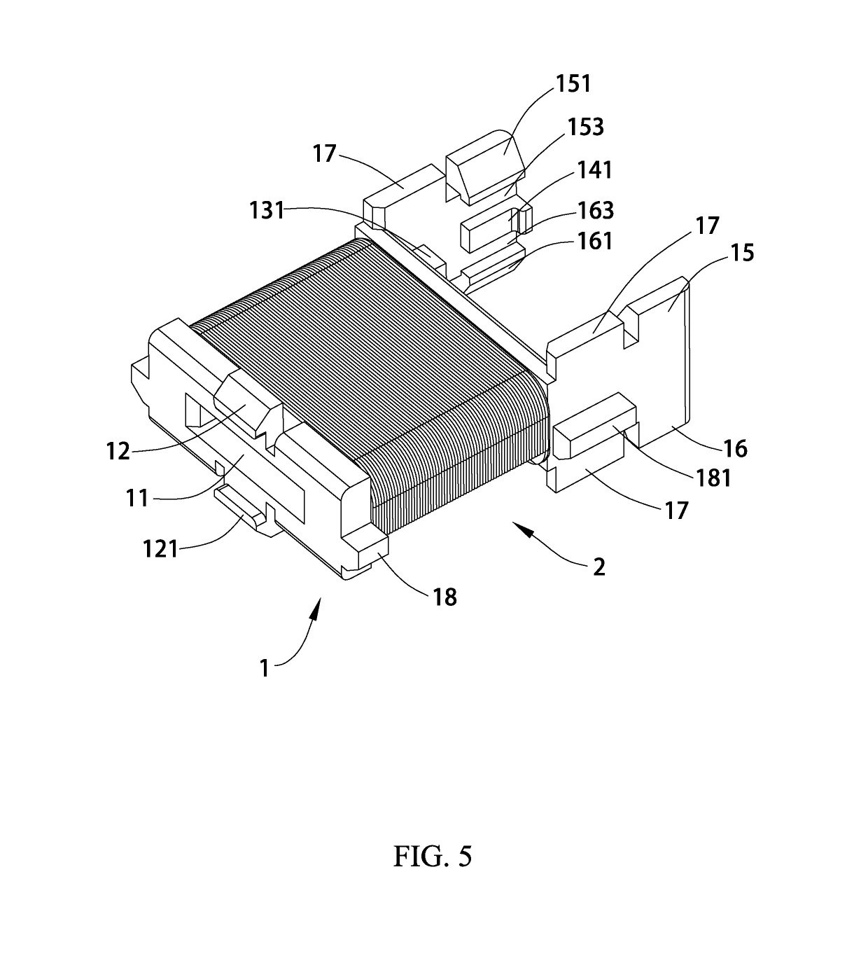

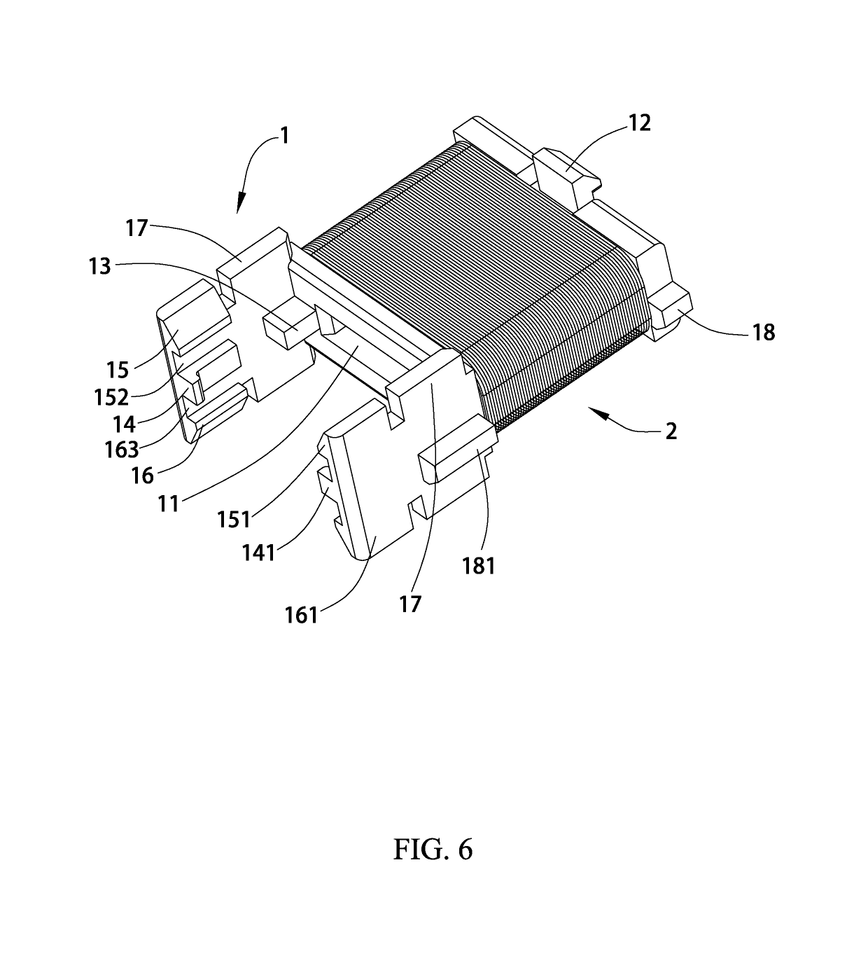

As shown in FIG. 5-6, a first buckle site 15 and a second buckle site 151 are provided, from front to rear, at the top of the other end of the bracket 1, a first clamping block 14 and a second clamping block 141 are provided, from front to rear, in the middle of the other end of the bracket 1, a first gap 152 is disposed between the first clamping block 14 and the first buckle site 15, a second gap 153 is disposed between the second clamping block 141 and the second buckle site 151, and the first slot is formed between the first gap 152 and the second gap 153; a third buckle 16 and a fourth buckle 161 are provided, from front to rear, at the bottom of the other end of the bracket 1, a third gap 162 is disposed between the first clamping block 14 and the third buckle 16, a fourth gap 163 is disposed between the second clamping block 141 and the fourth buckle 163, and the second slot is formed between the third gap 162 and the fourth gap 163.

\Specifically, convex platforms 17 are provided, from front to rear, at the bottom of the bracket 1 at the other end, a first avoidance groove 36 and a second avoidance groove 37 are also, from front to rear, provided at the right end of the first magnetic conductive plate 3 to abut against the convex platform 17, so that the second flanging 35 of the first magnetic conductive plate 3 can be more firmly inserted into the first gap 152 and second gap 153; the right end of the second magnetic conductive plate 4 is also provided with a third avoidance groove 46 and a fourth avoidance groove 47 to abut against the convex platform 17, and the fourth flanging 45 of the second magnetic conductive plate 4 is more firmly inserted into the third gap 162 and the fourth gap 163; during installation, the first magnetic conductive plate 3 is inserted into the first buckle 12 on the bracket 1 through the first slot 32, and then inserted into the first gap 152 and the second gap 153 on the other end of the bracket 1 through the second flanging 35, and fixed at the top of the bracket 1; the second magnetic conductive plate 4 is inserted into the second buckle 121 on the bracket 1 through the second slot 42, and then inserted into the third gap 162 and the fourth gap 163 at the other end of the bracket 1 through the fourth flanging 45, and fixed at the bottom of the bracket 1.

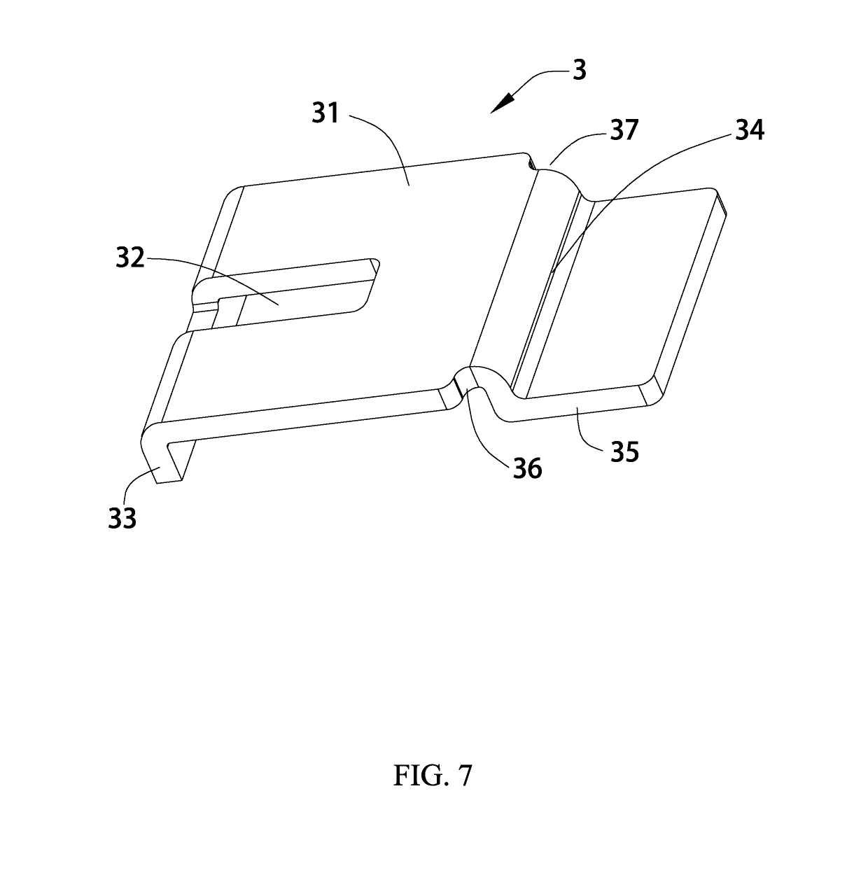

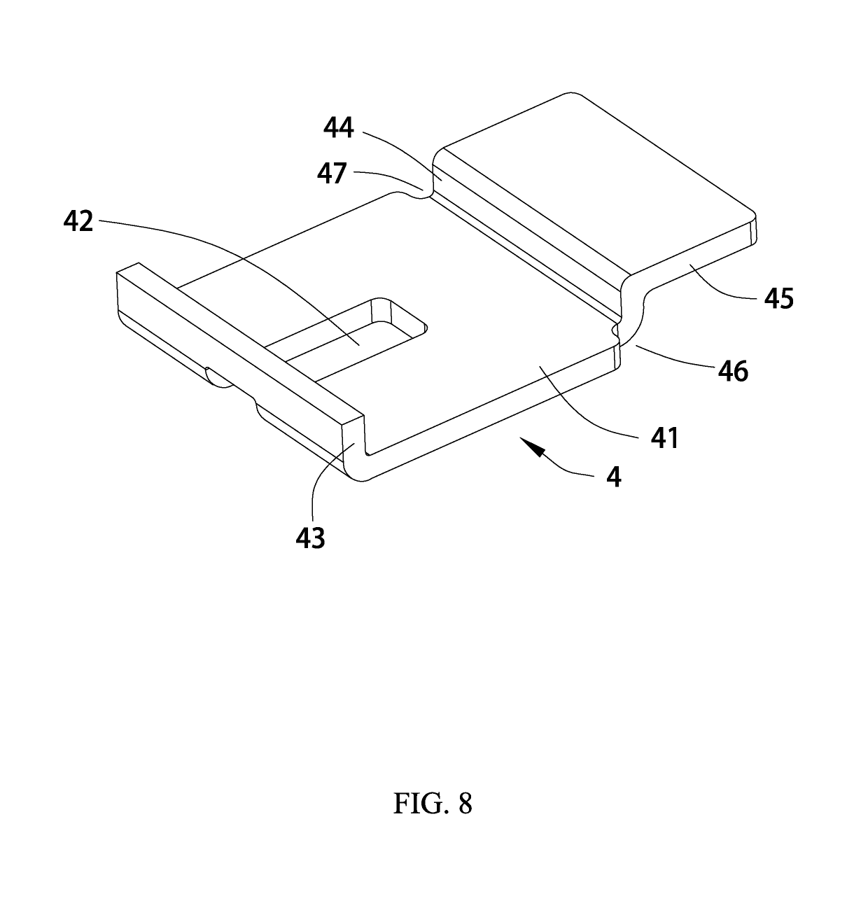

It should be noted that the first magnetic conductive plate 3 and the second magnetic conductive plate 4 have the same structure, as shown in FIG. 7-8 and, the upper and lower structures of the bracket 1 are symmetrical and, the first magnetic conductive plate 3 and the second magnetic conductive plate 4, when installed at the top and bottom of the bracket 1, respectively, are symmetrically disposed on both sides of the bracket 1.

Specifically, a first limit block 13 and a second limit block 131 are provided, front front to rear, in the middle of the other end of the bracket 1, the first limit block 13, second limit block 131, second clamping block 141, and first clamping block 14 enclose to form an installation groove in where the permanent magnet 6 is installed, and the first clamping block 14 and the second clamping block 141 are clamped on both sides of the permanent magnet 6, respectively.

In further, the miniature power generation device further comprises a magnetic swing plate 5, the bracket 1 is provided with a cavity 11 having two open ends, the upper and lower walls of the cavity are provided with two pivot points 111 for swinging that correspond vertically; the magnetic swing plate 5 is disposed in the cavity 11 and located between two pivot points 111, and swings up and down inside the cavity 11.

Specifically, the first magnetic conductive plate 3 further comprises a fifth flanging 33 disposed at the other end of the first planar portion 31 and folded downward; the second magnetic conductive plate 4 further comprises a sixth flanging 43 disposed at the other end of the second planar portion 41 and folded downward; when swinging up and down inside the cavity 11, the magnetic swing plate 5 abuts against the fifth flanging 33 and fourth flanging 45 to achieve magnetic conduction, or the sixth flanging 43 and second flanging 35 to achieve magnetic conduction.

It should be noted that in the embodiment, only one permanent magnet 6 is provided, and the volume of the permanent magnet 6 is sufficient to provide magnetic force for the device, ensuring that the magnetic field changes when the magnetic swing plate 5 swings, and the electric power generated due to the induction of magnetic field changes by the coil 2 will not affect its power supply during use. In addition, setting only one permanent magnet 6 also shortens the length of power generation device, further reducing the volume of power generation device, making it easy to install into a miniature electronic product and provide power supply.

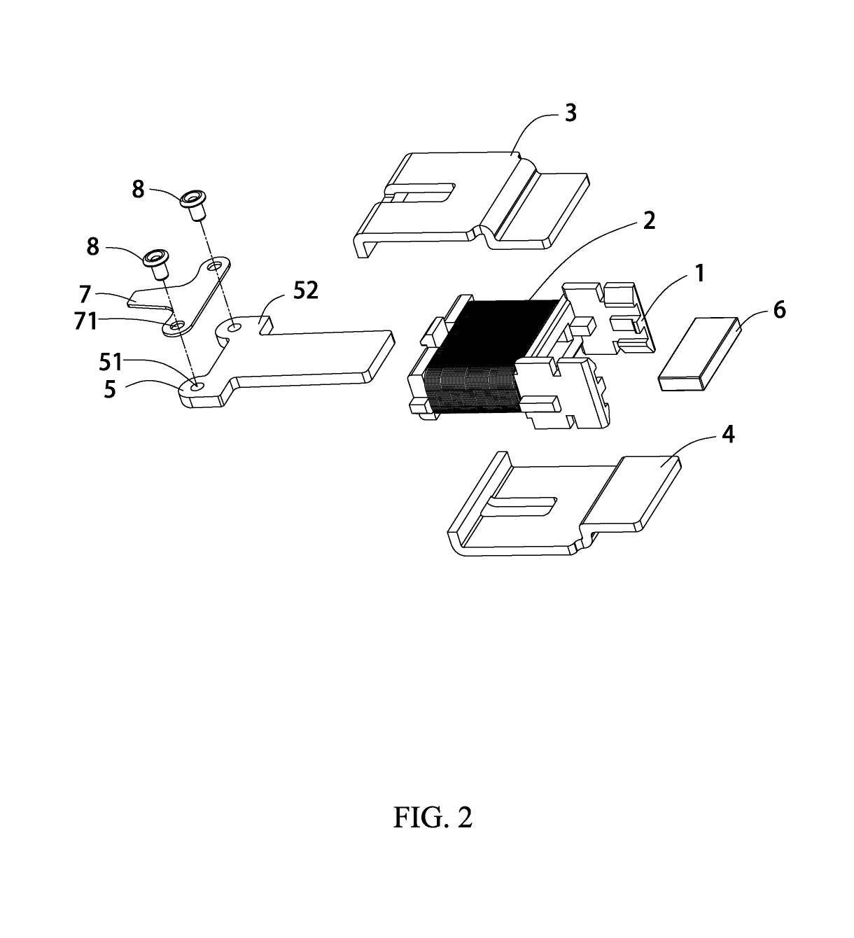

As shown in FIG. 2, the miniature power generation device further comprises a spring piece 7 disposed at one end of the magnetic swing plate 5, and the spring piece 7 during action drives the magnetic swing plate 5 to swing up and down in the cavity, so that magnetic swing plate 5 abuts against the fifth flanging 33 and the fourth flanging 45 to achieve magnetic conductivity, or the sixth flanging 43 and the second flanging 35 to achieve magnetic conduction, thereby causing a change in the magnetic force on the magnetic wing plate 5, that is, a change in the magnetic field, and in this case the coil 2 senses the change in its magnetic field and generates electricity, providing the required power supply for low-power electronic devices.

In further, one end of the magnetic swing plate 5 is provided with a first connection hole 51, the spring piece 7 is provided with a second connection hole 71, the spring piece 7 runs through the first connection hole 51 and the second connection hole 71 and is fixed on one end of the magnetic swing plate 5 by a fastener 8. One end of the magnetic swing plate 5 is provided with a convex block 52, and two first connection holes 51 are provided on both sides of the convex block 52.

It should be noted that in the embodiment, the first connection hole 51 and the second connection hole 71 can be screw holes, and the fastener 8 is a screw that passes through the first connection hole 51 and the second connection hole 71 and is tightened to fix the spring piece 7 on the convex patorm 52 at one end of magnetic swing plate 5 and meanwhile, the first connection hole 51 and the second connection hole 71 can also be through holes, and the fastener 8 is a rivet that passes through the first connection hole 51 and second connection hole 71 and is riveted to fix the spring piece 7 on the convex platform 52 at one end of the magnetic swing plate 5, which are not subject to specific limitation here.

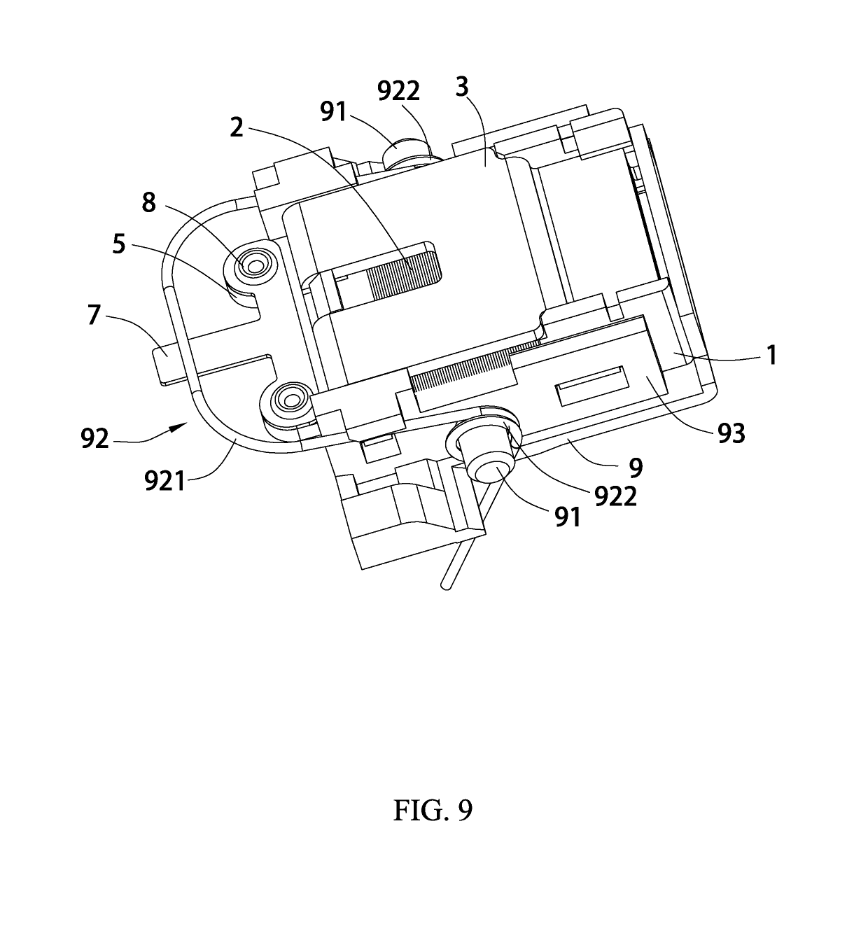

As shown in FIG. 9, the miniature power generation device further comprises a torsion spring 92 for providing upward reset elastic force to the spring piece 7, and the torsion spring 92 abuts against the spring piece 7. Specifically, in the embodiment, the miniature power generation device also includes a support 9 connected to the bracket 1, with protruding columns 91 and side edges 93 on both sides of the support 9, the side edges 93 on both sides of the support 9 abut against the two sides of the bracket 1 to improve the firmness of connection, and the torsion spring 92 includes a torsion spring body 921, and two torsion beams 922 that are respectively sleeved on the two protruding columns 91, the torsion spring body 921 abuts against the left end of spring piece 7; the spring piece 7, when pressed downwards, swings downwards and compresses the torsion spring 92 and, when the spring piece 7 is released or in a stationary state, the torsion spring 92 provides elastic force to make the spring piece 7 swing upwards and return to its original position.

It should be noted that in the embodiment, the torsion spring 92 with reset function can also be replaced with elastic components such as springs or reset elastic steel sheets;

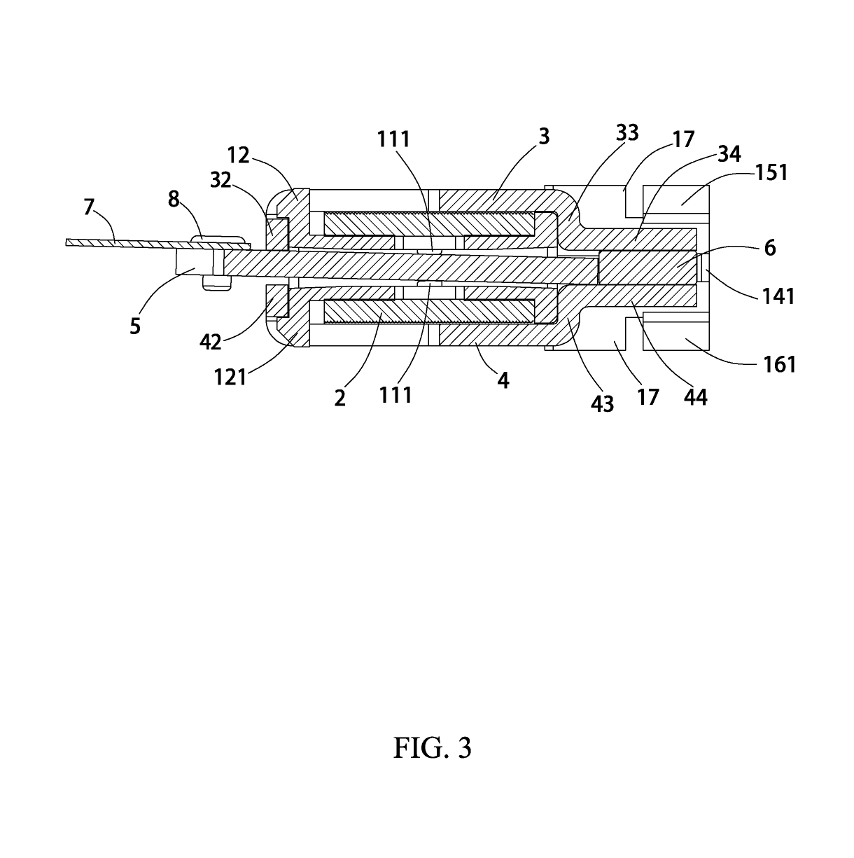

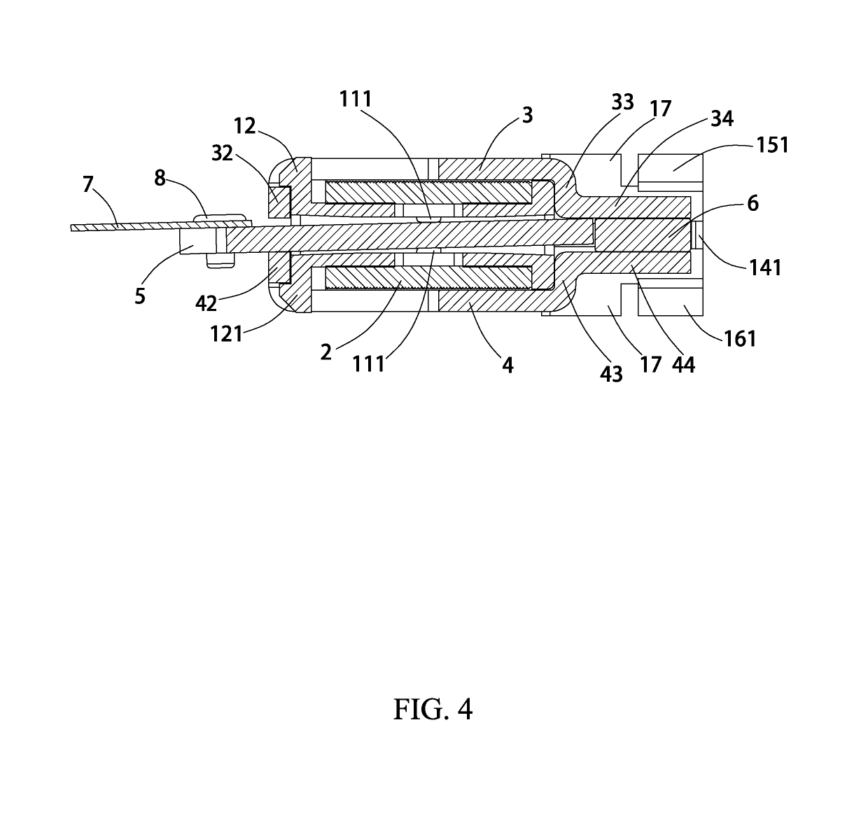

Referring to FIG. 3-4 again, during operation, when the spring 7 is pressed downwards and the torsion spring 92 is compressed, one end of the magnetic swing plate 5 is driven to swing downwards and make contact with the sixth flanging 43 for magnetic conductivity, while the other end of the magnetic swing plate 5, under the action of pivot point inside the cavity 11, swings upwards and makes contact with the second flanging 35, thus forming the first type of magnetic field; the spring piece 7, when released, can drive one end of the magnetic swing plate 5 to swing upward under the elastic force of torsion spring 92 and make contact with the fifth flanging 33 for magnetic conductivity, and under the action of pivot point 111 in the cavity 11, the other end of the magnetic swing plate 5 swings downward and makes contact with the fourth flanging 45, thus forming a second magnetic field opposite to the direction of first magnetic field, and the coil 2 generates electricity after inducing a changing magnetic field, and the electricity generated by the coil 2 can provide the required power supply for low-power electronic devices, and both ends of magnetic swing plate 5 produce magnetic changes and generate a large amount of electricity.

It should be noted that in the embodiment, referring to FIG. 3-4, inclined surfaces (not shown in the drawing) are also provided inside the cavity 11 and on both sides of the pivot point 111, and these inclined surfaces can allow the bottom of the fifth flanging 33 and the sixth flanging 43 to extend beyond the opening of the cavity 11, in order to avoid the magnetic swing plate 5 from contacting the inner wall of the cavity 11 during the swinging process, which would cause the magnetic swing plate 5 to not be in contact with the fifth flanging 33 and the sixth flanging 43 and affect the magnetic conducting effect when the magnetic swing plate 5 contacts the fifth flanging 33 and the sixth flanging 43.

Specifically, in the embodiment, the first flanging 34 and the first planar portion 31, the second flanging 35 and the first flanging 34, and the fifth flanging 33 and the first planar portion 31 are all provided with rounded transitions, in order to reduce stress concentration at the connection points between the first flanging 34 and the first planar portion 31, between the second flanging 35 and the first flanging 34, and between the fifth flanging 33 and the first planar portion 31, avoiding cracking at the folding position; in addition, the third flanging 44 and the second planar portion 41, the fourth flanging 45 and the third flanging 44, and the sixth flanging 43 and the second planar portion 41 are all provided with rounded transitions, in order to reduce stress concentration at the connection points between the third flanging 44 and the second planar portion 41, between the fourth flanging 45 and the third flanging 44, and between the sixth flanging 43 and the second planar portion 41, avoiding cracking at the folding position; the first groove 32 is disposed at the folding position between the fifth flanging 33 and the first planar portion 31; the second groove 42 is disposed at the folding position between the sixth flanging 43 and the second planar portion 41.

In further, a first locating protrusion 18 and a second locating protrusion 181 are provided on both sides of the bracket 1, which are used to install the self generating device of the present invention on low-power electronic devices for locating or clamping installation.

It should be noted that in the embodiment, the low-power electronic device can be a wireless switch or a wireless doorbell, etc.

In overall, the present invention provides a miniature power generation device, and setting up a first bending portion and a second bending portion avoids the need to add additional shims to fill the gap between the permanent magnet 6 and the first magnetic conductive plate 3 or the second magnetic conductive plate 4, also dispensing with additional clips, reducing the product volume, and facilitating combination use, thereby simplifying the production process and lowering manufacturing costs and in addition, it can avoid the influence of clips and magnetic shims on the direction of magnetic field, ensuring power generation efficiency and significantly improving the user experience.

For the miniature power generation device of the present invention, the first magnetic conductive plate 3 is also fixed on the top of the bracket 1 by being snap-fitted to the first buckle 12 through the first groove 32; the second magnetic conductive plate 4 is also fixed at the bottom of the bracket 1 by being snap-fitted to the second buckle 121 through the first groove 42, which improves the firmness of connection between the first magnetic conductive plate 3, the second magnetic conductive plate 4 and the bracket 1, while dispensing with additional magnetic shims and clips, reducing the volume, avoiding the influence of clips and magnetic shims on the direction of magnetic field, and ensuring power generation efficiency.

The miniature power generation device of the present invention provides an upward reset elastic force to the spring piece 7 by setting a torsion spring 92 in contact with the spring piece 7, so that the spring piece 7 is in an upward position in a stationary state and prepares for the next downward press; the elastic force of the torsion spring 92 reduces the force required for upward pressing, thereby reducing the number of presses and ensuring power generation efficiency.

It should be noted that when a component is referred to as "fixed to" or "disposed at" another component, it can be directly or indirectly on the other component. When a component is referred to as "connected" to another component, it can be directly or indirectly connected to that other component.

It should be understood that the orientation or positional relationships indicated by terms such as "top", "bottom", "inside", "outside", etc. are based on those shown in the accompanying drawings, only for the convenience of describing the present invention and simplifying the description, rather than indicating or implying that the modules or elements referred to must have a specific orientation, be constructed and operated in a specific orientation, and therefore they cannot be understood as limiting the present invention.

In addition, in the description of the present invention, "a plurality of" and "several" means two or more, unless otherwise specifically limited.

The technical means disclosed in the present invention are not limited to those disclosed in the above embodiments, but also include technical solutions composed of any combination of the above technical features. It should be noted that for person having ordinary skill in the art, several improvements and embellishments can be made without departing from the principles of the present invention, which are also considered within the scope of protection of the present invention.

What is claimed is:

1. A miniature power generation device, comprising:
a bracket and a coil, wherein the coil is wound around the bracket;
a first magnetic conductive plate comprising a first planar portion and a first bending portion disposed at one end of the first planar portion; the first bending portion comprises a first flanging connected to one end of the first planar portion and disposed vertically, and a second flanging disposed horizontally and located at the bottom of the first flanging;
a second magnetic conductive plate comprising a second planar portion and a second bending portion disposed at one end of the second planar portion; the second bending portion comprises a third flanging connected to one end of the second planar portion and disposed vertically, and a fourth flanging disposed horizontally and located at the bottom of the third flanging;
a permanent magnet disposed at one end of the bracket;
one end of the bracket is, from upper to lower, provided with a first slot and a second slot, and the second flanging is inserted into the first slot to be fixed at the top of the bracket, and the second flanging is inserted into the top of the permanent magnet to achieve magnetic conductivity; the fourth flanging is inserted into the second slot to be fixed at the bottom of the bracket, and the fourth flanging abuts against the bottom of the permanent magnet to achieve magnetic conductivity.

2. The miniature power generation device according to claim 1, wherein a first buckle and a second buckle are, from upper to lower, provided at the other end of the bracket, the first magnetic conductive plate is provided with a first groove that fits the first buckle, the second magnetic conductive plate is provided with a second groove that fits the second buckle, the first groove is snap-fitted to the first buckle, and the second groove is snap-fitted to the second buckle to fix the first magnetic conductive plate and the second magnetic conductive plate on the upper side and lower side of the bracket, respectively.

3. The miniature power generation device according to claim 1, wherein a first buckle site and a second buckle site are provided, from front to rear, at the top of the other end of the bracket, a first clamping block and a second clamping block are provided, from front to rear, in the middle of the other end of the bracket, a first gap is disposed between the first clamping block and the first buckle site, a second gap is disposed between the second clamping block and the second buckle site, and the first slot is formed between the first gap and the second gap;
a third buckle and a fourth buckle are provided, from front to rear, at the bottom of the other end of the bracket, a third gap is disposed between the first clamping block and the third buckle, a fourth gap is disposed between the second clamping block and the fourth buckle, and the second slot is formed between the third gap and the fourth gap.

4. The miniature power generation device according to claim 3, wherein a first limit block and a second limit block are provided, front front to rear, in the middle of the other end of the bracket, the first limit block, second limit block, second clamping block, and first clamping block enclose to form an installation groove in where the permanent magnet is installed, and the first clamping block and the second clamping block are clamped on both sides of the permanent magnet, respectively.

5. The miniature power generation device according to claim 1, further comprising a magnetic swing plate, the bracket is provided with a cavity having two open ends, the upper and lower walls of the cavity are provided with two pivot points for swinging that correspond vertically; the magnetic swing plate is disposed in the cavity and located between two pivot points, and swings up and down inside the cavity.

6. The miniature power generation device according to claim 5, wherein the first magnetic conductive plate further comprises a fifth flanging disposed at the other end of the first planar portion and folded downward; the second magnetic conductive plate further comprises a sixth flanging disposed at the other end of the second planar portion and folded downward;
when swinging up and down inside the cavity, the magnetic swing plate abuts against the fifth flanging and fourth flanging to achieve magnetic conduction, or the sixth flanging and second flanging to achieve magnetic conduction.

7. The miniature power generation device according to claim 6, further comprising a spring piece disposed at one end of the magnetic swing plate, and the spring piece during action drives the magnetic swing plate to swing up and down in the cavity.

8. The miniature power generation device according to claim 7, wherein one end of the magnetic swing plate is provided with a first connection hole, the spring piece is provided with a second connection hole, the spring piece runs through the first connection hole and the second connection hole and is fixed on one end of the magnetic swing plate by a fastener.

9. The miniature power generation device according to claim 8, further comprising a torsion spring for providing upward reset elastic force to the spring piece, and the torsion spring abuts against the spring piece.

10. The miniature power generation device according to claim 6, wherein the first flanging and the first planar portion, the second flanging and the first flanging, and the fifth flanging and the first planar portion are all provided with rounded transitions;
the third flanging and the second planar portion, the fourth flanging and the third flanging, and the sixth flanging and the second planar portion are all provided with rounded transitions.
